(19) United States
(12) Patent Application Publication
(10) Pub. No.: US 2004/0215478 A1
(43) Pub. Date: Oct. 28, 2004

(54) Method of providing a unique identifier for a mailpiece

(76) Inventors: Christopher A. Baker, New Canaan, CT (US); Douglas B. Quine, Bethel, CT (US); Cortland D. Starrett, Brookston, IN (US)

Correspondence Address: Pitney Bowes Inc., Intellectual Property & Technology Law Department, 35 Waterview Drive, P.O. Box 3000, Shelton, CT, 06484, US

(21) Appl. No.: 10/738,941

(22) Filed: Dec. 17, 2003

Related U.S. Application Data
(60) Provisional application No. 60/436,350, filed on Dec. 24, 2002.

(51) Int. Cl. G06F 17/60

(52) U.S. Cl. 705/1

(57) ABSTRACT

A method for generating PLANET service codes for a batch of mailpieces with the PLANET service code having assignable digits. The PLANET service code is changed to provide a unique tracking number for each mailpiece determinative upon whether a POSTNET service code is known for each mailpiece in the batch of mailpieces, and if known, whether that POSTNET service code was applied to a previous mailpiece in the batch of mailpieces.

### CROSS REFERENCE TO RELATED APPLICATION

This application claims priority under 35 U.S.C. section 119(e) from Provisional Patent Application Serial No. 60/436,350, filed Dec. 24, 2002, entitled SYSTEM AND METHOD FOR TRACKING MAILIPIECES (Attorney Docket Number F-613) which is incorporated herein by reference in its entirety.

### FIELD OF THE INVENTION

The present invention relates to a method for tracking a mailpiece in a postal processing system. More particularly, the present invention relates to a method for providing a unique PLANET code identifier to a mailpiece that is used for tracking the mailpiece through a postal processing system.

### BACKGROUND OF THE INVENTION

Mailpieces have traditionally used barcodes to control mailpiece inserting and sorting operations. Barcodes are also used on a mailpiece to facilitate delivery of the mailpiece. For example, a POSTNET barcode placed on a mailpiece is used by the United States Postal Service to control delivery of a mailpiece in a mainstream. A POSTNET barcode typically is formed by either a 9 or 11 digit zip code that corresponds to a specific geographic region designated by the United States Postal Service for facilitating mailpiece delivery. Thus, all mail recipients in such a specific geographic region may be assigned a common POSTNET.

Recently, the United States Postal Service has implemented the use of PLANET codes to track mail electronically once the mailpiece enters the mail stream. The United States Postal Service offers two types of PLANET code services, namely origin CONFIRM and destination CONFIRM. Both of which are briefly described below.

The Origin CONFIRM service enables a mailer to access data regarding when a return mailpiece has been sent, typically in the format of a business reply mailpiece. The mainstream sortation equipment of the United States Postal Service scans the mail as part of sorting and routing the mail throughout the U.S. and allows a customer to access information regarding when a return mailpiece has been mailed. Each time the mailpiece is scanned as part of the sortation process the information (e.g., POSTNET and PLANET code barcodes) is recorded in a USPS confirm server. The mailer then has access to the data (multiple instances of) located on the USPS confirm server. For example, the United States Postal Service can provide code readers that read POSTNET and PLANET codes from mailpieces at various locations in the mail stream. For example, these readers are located at postal service mail sorting sites. These readers can be in communication with the United States Postal Service CONFIRM server, which logs into the confirm server database the date, time and location when a particular mailpiece passes through the multiple postal service mail delivery stream scan point locations. Thus, the origin CONFIRM service can be used to verify that a communication has been remitted by a customer.

When using origin CONFIRM service, the mailpiece includes both a POSTNET and PLANET code barcode. The POSTNET barcode is the POSTNET assigned by the United States Postal Service for the mailers location. And the origin CONFIRM barcode is a 12 or 14 digit barcode where the first two digits represent the PLANET barcode being used for origin CONFIRM service with the next 9 or 11 digits identifying the mailpiece to the mailer (as chosen by the mailer), and the last digit is a check-sum digit that helps the United States Postal Service detect errors.

Regarding the destination CONFIRM service, it enables mailers to access the confirm database of the United States Postal Service to access the date, time and scan point of the mailpiece being routed to the customer. The mailer can get access to the time the mailpiece was delivered to the carrier for delivery to the customer. As with the origin CONFIRM service, the destination CONFIRM service can be implemented by the Postal Service using the same readers described above and a server to communicate destination confirmation information to the mailer.

Like the origin CONFIRM service, when using destination CONFIRM service, the mailpiece includes both a POSTNET and PLANET code barcode. The POSTNET barcode is the POSTNET assigned by the United States Postal Service for the recipient of the mailpiece being sent by the mailer. The destination CONFIRM service code is a 12 or 14 digit barcode where the first two digits represents the PLANET barcode is being used for origin CONFIRM service with the next 9 or 11 digits identify the mailer and the mailpiece. Specifically, of these 9 or 11 digits, the first five digits is a unique (and fixed) 5-digit ID assigned by the United States Postal Service to identify mailers subscribed to the PLANET code service offering. The next four (4) or six (6) digit field is the mailing (or customer) ID that is defined and assignable by the mailer to identify a mailpiece to that mailer. Currently only a four (4) digit assignable field is used for the mailing (or customer) ID.

Even though the PLANET code service offering is advantageous to mailers for enabling them to track outgoing (destination CONFIRM) and incoming (origin CONFIRM) mailpieces, it does have shortcomings. Notably, destination CONFIRM only currently provides the mailer with a four (4) digit field for providing a unique ID for each mailpiece being sent. Thus, and especially on large volume mailings, the mailer cannot ensure uniqueness for mailpieces being delivered to the same address or addresses having the same POSTNET, and the customer ID suggestion can often cause duplicate PLANET codes from being delivered to the same customer across different mailings of the mailer and possible jeopardize a customers confidentiality by identifying the customer with a static customer ID. For example, single mailpieces going to separate addresses, like one person per household, the destination CONFIRM code can identify the exact mailpiece being tracked as to who should be receiving it. However, if the destination CONFIRM mailpieces are being delivered to multiple persons at a residence or business, then there is no way to tell who the tracking information belongs to as the PLANET and POSTNET codes are identical for each such person.

Further, since the United States Postal Service is currently only offering mailers with a four (4) digit assignable field for providing uniqueness to a mailpiece, then the mailers are only provided with 10,000 different numerical combinations to provide uniqueness to mailpieces. Thus, if a mail batch to be sent contains more than 10,000 mailpieces, duplicative four (4) digit assignable fields must be used if each mailpiece was to be assigned a different four (4) digit assignable field, which could lead to confusion in identifying mailpieces when common POSTNET and PLANET barcodes are present on at least two mailpieces.

### SUMMARY OF THE INVENTION

An object of the present invention is to overcome the noted shortcomings of a PLANET service code mailpiece by providing uniqueness to each mailpiece having a destination CONFIRM PLANET code delivered to recipients having a common POSTNET service code.

The above object of the present invention is accomplished by providing a method for generating a PLANET service code for a batch of mailpieces with the PLANET service code having assignable digits. The method includes the steps of altering the assignable digits in a PLANET service code so as to provide a unique tracking number for each mailpiece determinative upon whether a POSTNET service code is known for each mailpiece in the batch of mailpieces, and if known, whether that POSTNET service code was applied to a previous mailpiece in the batch of mailpieces.

### BRIEF DESCRIPTION OF THE DRAWINGS

The above and other objects of the present invention will become apparent upon consideration of the following detailed description, taken in conjunction with the accompanying drawings, in which like reference numerals refer to like parts throughout, and in which:

FIG. 1 is an illustration of a mailpiece having a POSTNET and PLANET service barcode;

FIGS. 2 and 3 depict block diagrams of an exemplary system used for generating and processing PLANET service barcodes;

FIG. 4 is an illustrative image of a destination CONFIRM service code;

FIG. 5 depicts a flow-chart for generating a destination CONFIRM service code when the POSTNET is unknown;

FIG. 6 depicts a flow-chart for generating a destination CONFIRM service code when the POSTNET is known; and

FIG. 7 depicts a flow-chart for generating a destination CONFIRM service code when the POSTNET may or may not be known.

### DETAILED DESCRIPTION OF THE PREFERRED EMBODIMENT

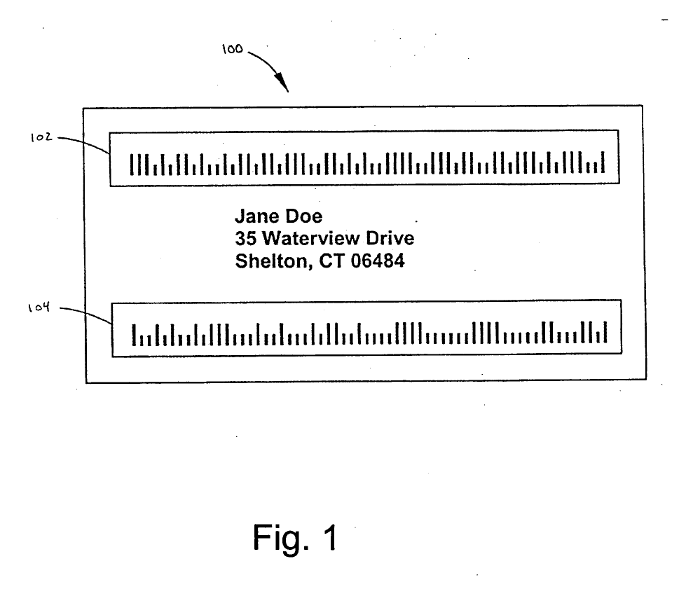

Referring to FIG. 1, exemplary postal service mailpiece codes suitable for use by the present invention are illustrated. Reference numeral 100 generally designates the address block of a conventional mailpiece. Such an address block can either be printed on the outside of an envelope or on a mailpiece inserted in an envelope such that address block 100 is visible through a window in the envelope. For the purposes of the present invention, address block 100 includes United States Postal Service PLANET service code 102 and POSTNET service code 104. PLANET service code 102 is a bar code in which bars of varying height are used to encode any suitable information, such as a service type, a customer ID or mailing and subscriber ID and a checksum. The first two digits of the PLANET code typically indicate a desired service type. For example, according to current United States Postal Service standards, the digits 21 indicate origin CONFIRM and 22 indicates destination CONFIRM service.

As previously mentioned, it is an object of the present invention to provide a process that generates a unique destination CONFIRM service code for each mailpiece, and preferably for each mailpiece present in a “mail batch.” Briefly, a “mail batch” is a batch of mailpieces generated by a mailer and targeted for a group of recipients. For example, a “mail batch” can consist of monthly credit card billing statements for a particular bank.

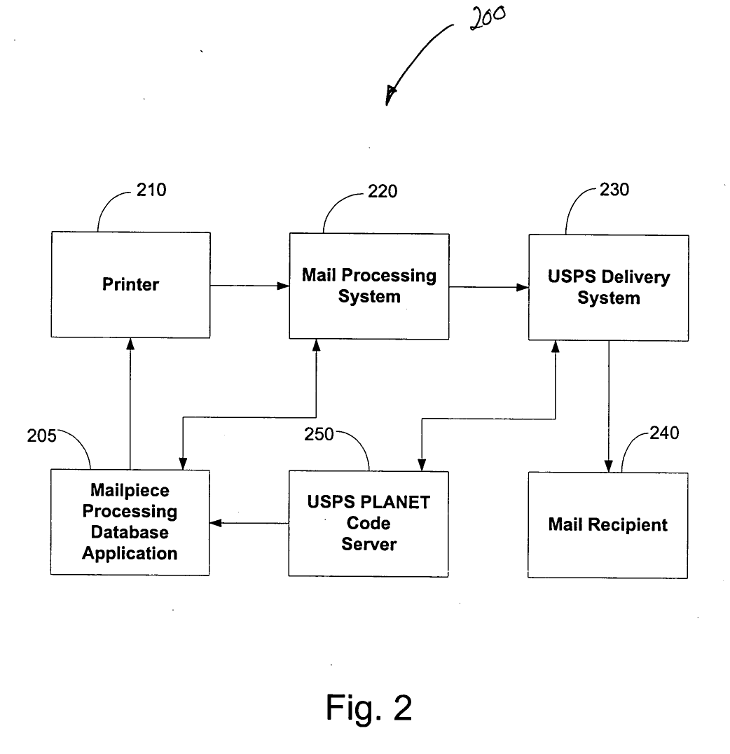

As shown in FIG. 2, there is illustrated an overall system for controlling mailpiece processing and tracking using a postal service mailpiece code according to an embodiment of the present invention. In FIG. 2, a mailpiece processing and tracking system, generally designated 200, includes components that create a mailpiece to be placed in a mail stream. For example, system 200 includes a mailpiece processing database application 205 that generates print data to be printed on a mailpiece. Such an application can be a computer program executing on a general purpose computer that generates the mailpiece print data. Such mailpiece data can include the actual information content of a mailpiece. For example, if the mailpiece is a bill, the print data can include the address of the recipient of the bill and the billing information.

In accordance with the present invention, it is to be understood that the mailpiece processing database application 205 may or may not know the POSTNET service codes to be assigned to mailpieces in a processing mail batch. If not known, then typically the POSTNET service code will be assigned to each such mailpiece at a later stage in the processing of the mailpiece.

Typically, the mailpiece processing database application 205 is coupled to, or integrated with a print data manipulator (not shown) that receives the print data from application 205. Like application 205, a print data manipulator can be a program executing on a general purpose computer. An example of a print data manipulator program suitable for use with the present invention is the StreamWeaver™ product commercially available from Pitney Bowes Inc. of Stamford, Conn. In response to receiving the print data, a print data manipulator can reformat and add additional print data, such as the PLANET code and POSTNET code, and deliver pertinent information to printer 210 and mailpiece processing database application 205. Mailpiece processing database application 205 stores the information received from print data manipulator in a mailpiece processing database 310 (as described below).

Preferably coupled to, or integrated with printer 210 is a mailpiece processing system or systems 220, such as an inserting system and sorter. Such an inserting system is responsible for inserting the correct materials in the correct envelopes. For example, mail to be delivered to telephone bill recipients may include one set of promotional inserts while mail to be delivered to car owners may include another set. Once a mailpiece is generated via mail processing system 220, the mailpiece enters the United States Postal Delivery System 230, which delivers the mailpiece(s) to intended recipients 240 via its POSTNET barcode 104 and also tracks the mailpiece for the mailer via the PLANET code barcode 102. To enable mailpiece tracking, the United States Postal Service delivery system 230 is provided with a PLANET code server 250 that selectively communicates tracking information from the mail stream of the United States Postal Service to preferably a mailer's mailpiece processing database application 205.

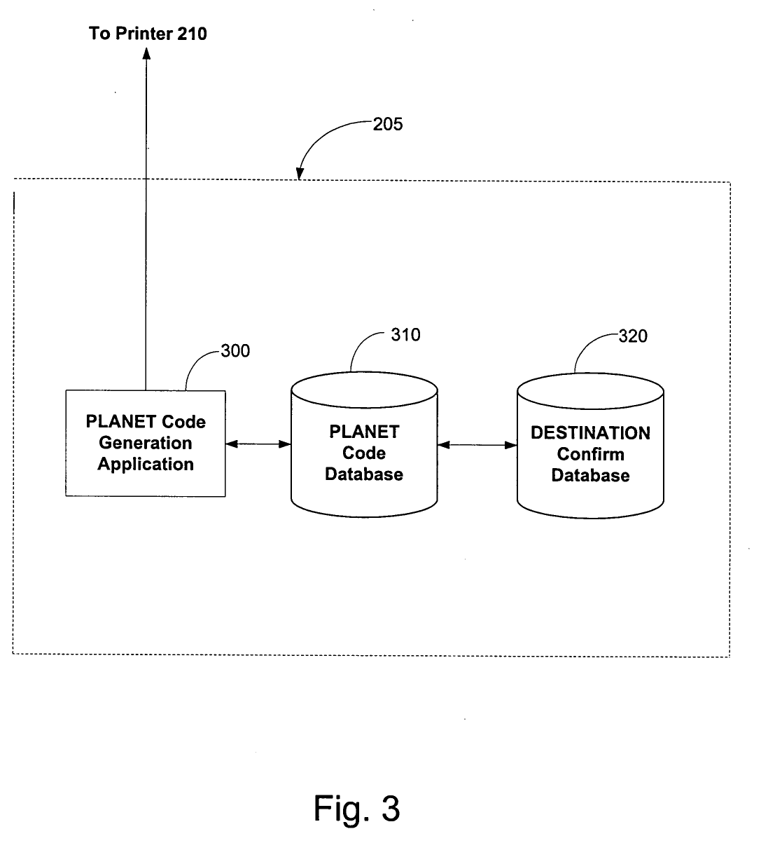

Referring now to FIG. 3, the mailpiece processing database application 205 is shown in more detail. It preferably consists of a PLANET code generation application 300 that is preferably a software program used for generating either origin or destination CONFIRM barcodes. Once generated, these barcodes are preferably stored in a database structure for later retrieval for mailpiece tracking purposes. As the database structure may vary greatly, for ease of description of the present invention an exemplary database structure is shown. Thus, the present invention is not to be understood to be limited to what is shown in FIG. 3 but may encompass any suitable database structure meeting the needs of a user. In this exemplary embodiment, a PLANET code database 310 stores all generated PLANET codes preferably in correlation with associated mailpieces. Database 310 preferably includes a sub-database, namely a destination CONFIRM database 320 for storing generated destination CONFIRM service codes.

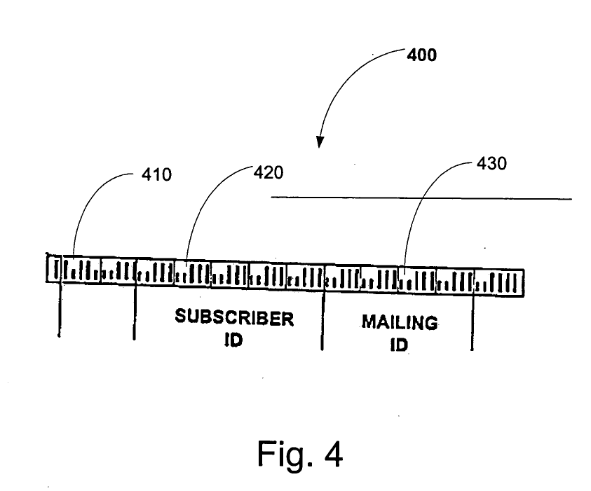

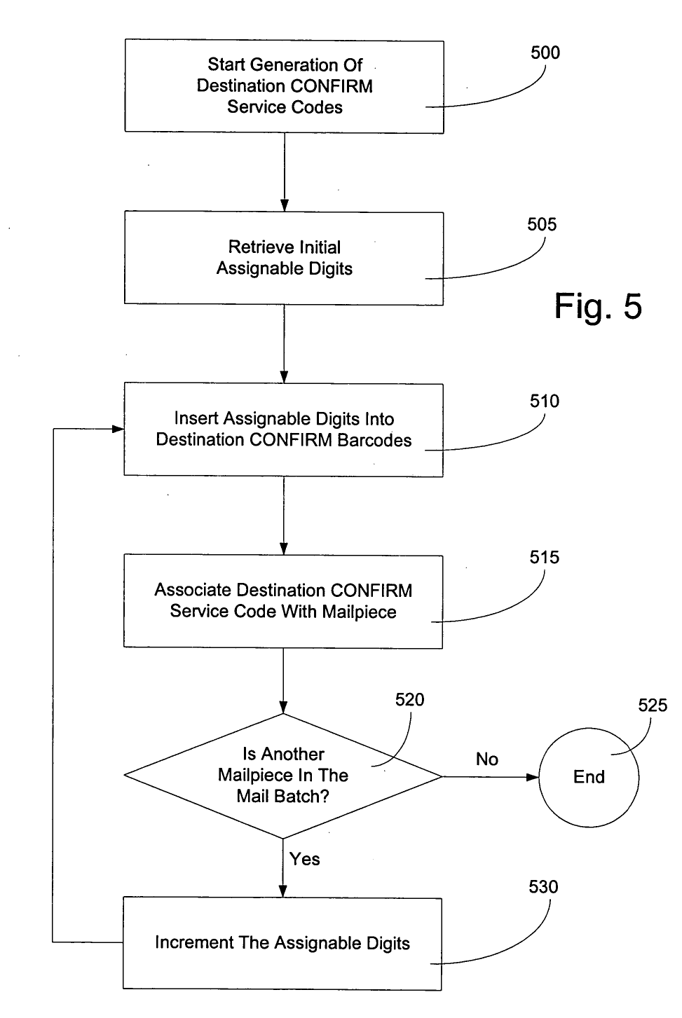

With reference now to FIGS. 4 and 5, the method for generating a destination PLANET service code 400 when the POSTNET service code 104 for each mailpiece in a mail batch is unknown, will now be described.

As previously mentioned, the destination CONFIRM service code 400 is currently a barcode wherein the first two digits 410 designate that the PLANET service barcode is being used for destination CONFIRM service, the next first five digits 420 is a unique (and fixed) 5-digit ID assigned by the United States Postal Service to identify mailers subscribed to the PLANET code service offering. And the next four (4) digit field 430 is the mailing (or customer) ID that is defined by the mailer to identify a mailpiece to that mailer. It is this four digit field 430 that is assignable by the mailer, which enables the mailpiece to be uniquely identifiable to the mailer.

The method for generating the assignable four digit field 430 starts at step 500 in which the PLANET code generation application 300 (FIG. 3) receives a command to start generating destination CONFIRM service codes 400, preferably for a batch of mailpieces to be mailed by a mailer. Beginning at step 505, PLANET code generation application 300 retrieves an initial four digit value for the assignable four digit field 430 of the destination CONFIRM service code (e.g., 0445). This initial four digit value can be chosen arbitrarily, or can be based upon prescribed criteria of the mailer. Next, the initial four digits for the assignable four digit field 430 is then inserted as the assignable four digit field 430 in a destination CONFIRM service code 400 at step 510. The destination CONFIRM service code generated at step 510 is then associated with a particular mailpiece and preferably stored in the destination CONFIRM database 320 (FIG. 3), step 515. A determination is then made as to whether another mailpiece is present in the processing batch of mail requiring a destination CONFIRM service codes, step 520. If no, then this process ends, step 525, and will repeat itself when another batch of mail requiring destination CONFIRM barcodes is to be sent by the mailer when the POSTNET service code for each mailpiece in the mail batch is unknown, step 500.

If another mailpiece is present in the processing batch of mail, step 520, then the current four digits for the assignable four digit field 430 is preferably increased by a one count (e.g., 0446), step 530, and the process returns to step 510 for this next mailpiece. Thus, since the POSTNET is not yet known for each mailpiece in the processing mail batch, sequentially changing the assignable four digit field 430 for each destination CONFIRM service code to be associated with each respective mailpiece in the mail batch significantly increases the probability that if multiple mailpieces are addressed to a common POSTNET service code region then each of the mailpieces will have a unique destination CONFIRM service code to ensure accurate tracking by the mailer.

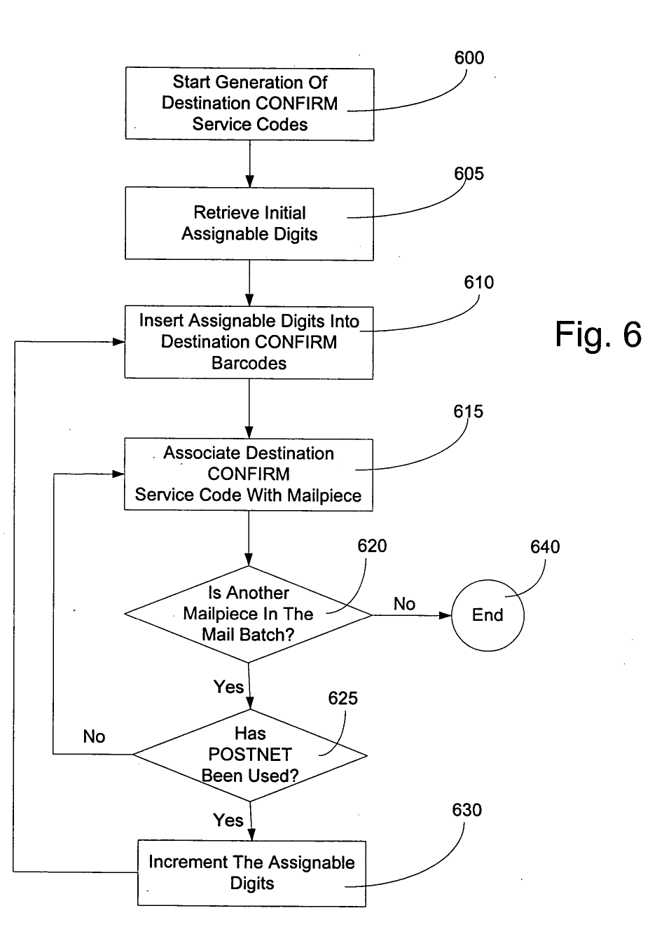

With reference now to FIGS. 4 and 6, the method for generating a destination PLANET service code when the POSTNET service code 104 for each mailpiece in a mail batch is known, will now be described.

The method for generating the assignable four digit field 430 starts at step 600 in which the PLANET code generation application 300 (FIG. 3) receives a command to start generating destination CONFIRM service codes 400, preferably for a batch of mailpieces to be mailed by a mailer with then POSTNET for each mailpiece is known. Beginning at step 605, PLANET code generation application 300 retrieves an initial four digit value for the assignable four digit field 430 of the destination CONFIRM service code (e.g., 0017). This initial four digit value can be chosen arbitrarily, or can be based upon prescribed criteria of the mailer. Next, the initial four digits for the assignable four digit field 430 is then inserted as the assignable four digit field 430 in a destination CONFIRM service code 400 at step 610. The destination CONFIRM service code generated at step 610 is then associated with a particular mailpiece and preferably stored in the destination CONFIRM database 320 (FIG. 3), step 615. A determination is then made as to whether another mailpiece is present in the processing batch of mail requiring a destination CONFIRM service code, step 620. If no, then this process ends, step 640, and will repeat itself when another batch of mail requiring destination CONFIRM service codes is to be sent by the mailer when the POSTNET service code for each mailpiece in the mail batch is unknown, step 600.

If another mailpiece is present in the processing batch of mail, step 620, then a determination is made as to whether the another mailpiece in the current processing batch of mail is assigned a POSTNET service code that has been assigned to a previous processed mailpiece, step 625. Preferably this is performed by polling the mailpiece data present in the destination CONFIRM database 320. If an identical POSTNET service code has not been previously associated with any of the already processed mailpieces, then the process returns to step 615 whereby the current destination CONFIRM service code (e.g., 0017) is then associated with the current processing mailpiece and is preferably stored in the destination CONFIRM database 320 (FIG. 3), step 615.

Conversely, if the POSTNET service code has been previously associated with an already processed mailpiece (step 625), then the current four digits for the assignable four digit field 430 is preferably increased by a one count (e.g., 0018), step 630, and the process returns to step 610 whereby the destination CONFIRM service code having the incremented assignable four digits is then associated with the current processing mailpiece and is preferably stored in the destination CONFIRM database 320 (FIG. 3), step 615.

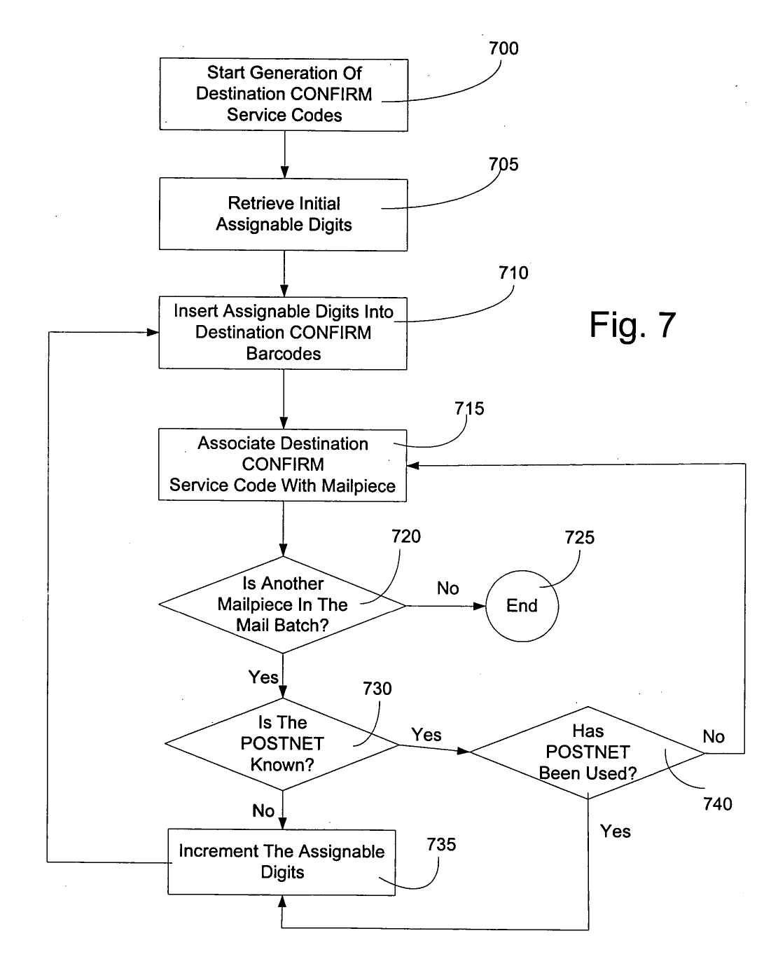

Hence, and as explained above, since the POSTNET service code for each mailpiece is known prior to the assignment of a destination CONFIRM service code, in order to preserve the limited number of unique destination CONFIRM service codes available to a mailer, a specific destination CONFIRM service code is permitted to have repeated assignments with mailpieces in a processing mail batch. However, once a mailpiece is detected having a POSTNET service code that was previously assigned to another previous processed mailpiece in the processing mail batch, the assignable four digits of the destination CONFIRM service is changed to ensure uniqueness for each mailpiece being delivered to a common POSTNET service code region. With reference now to FIGS. 4 and 7, the method for generating a destination PLANET service code when the POSTNET service code 104 for each mailpiece in a mail batch may be either known or unknown, will now be described.

The method for generating the assignable four digit field 430 starts at step 700 in which the PLANET code generation application 300 (FIG. 3) receives a command to start generating destination CONFIRM service codes 400, preferably for a batch of mailpieces to be mailed by a mailer when the POSTNET service code for each mailpiece in the processing mail batch is either known or unknown. Beginning at step 705, PLANET code generation application 300 retrieves an initial four digit value for the assignable four digit field 430 of the destination CONFIRM service code 400. This initial four-digit value (e.g., 0014) can be chosen arbitrarily, or can be based upon prescribed criteria of the mailer. Next, the initial four digits for the assignable four digit field 430 is then inserted as the assignable four digit field 430 in a destination CONFIRM service code 400 at step 710. The destination CONFIRM service code generated at step 710 is then associated with a particular mailpiece and preferably stored in the destination CONFIRM database 320 (FIG. 3), step 715. A determination is then made as to whether another mailpiece is present in the processing batch of mail requiring assignment of a destination CONFIRM service code, step 720. If no, then this process ends, step 725, and will repeat itself when another batch of mail requiring assignment of destination CONFIRM service codes is to be sent by the mailer when the POSTNET service code for each mailpiece in the processing mail batch is either known or unknown, step 700.

If another mailpiece is present in the processing batch of mail, step 720, then a determination is made as to whether the POSTNET service code 104 for that mailpiece is known or unknown, step 730. If the POSTNET service code 104 to be assigned to the mailpiece is not yet known, then the current four digits for the assignable four digit field 430 is preferably increased by a one count (e.g., 0015), step 735, and the process returns to step 710 whereby the destination CONFIRM service code having the incremented assignable four digits (e.g., 0015) is then associated with the current processing mailpiece and is preferably stored in the destination CONFIRM database 320 (FIG. 3), step 715.

If the POSTNET service code to be assigned to the mailpiece is known (step 730), then a determination is made as to whether the another mailpiece in the current processing batch of mail has been assigned a POSTNET service code which has been associated with a previous processed mailpiece, step 740. Preferably this is performed by polling the mailpiece data present in the destination CONFIRM database 320. If an identical POSTNET service code has not been previously associated with any of the already processed mailpieces, then the process returns to step 715 whereby the current destination CONFIRM service code (e.g., 0014) is associated with the current processing mailpiece and is preferably stored in the destination CONFIRM database 320 (FIG. 3), step 715.

And if the another mailpiece having a known assigned POSTNET service code in the processing batch of mail, which known assigned POSTNET service code has been associated with a previous processed mailpiece, (step 740), then the current four digits for the assignable four digit field 430 is increased by a one count (e.g. 0015), step 735, and the process returns to step 710 whereby the destination CONFIRM service code having the incremented assignable four digits (e.g., 0015) is then associated with the current processing mailpiece and is preferably stored in the destination CONFIRM database 320 (FIG. 3), step 715.

Hence, and as explained above, since the POSTNET service code for each mailpiece may be either known or unknown prior to the assignment of a destination CONFIRM service code, in order to preserve the limited number of unique destination CONFIRM service codes available to a mailer, a specific destination CONFIRM service code is permitted to have repeated assignments with mailpieces in a processing mail batch for each mailpiece having a different POSTNET service code relative to previous processed mailpieces. However, for each mailpiece wherein the assigned POSTNET service code is not yet known, or when known but has been detected as being already assigned to another previous processed mailpiece in the processing mail batch, the assignable four digits of the destination CONFIRM service to be assigned to the mailpiece is changed to ensure uniqueness for each mailpiece.

In summary, a method for generating destination CONFIRM service codes has been described. Although the present invention has been described with emphasis on particular embodiments, it should be understood that the figures are for illustration of the exemplary embodiment of the invention and should not be taken as limitations or thought to be the only means of carrying out the invention. Further, it is contemplated that many changes and modifications may be made to the invention without departing from the scope and spirit of the invention as disclosed.

What is claimed is:

1. A method for generating a PLANET service code for a batch of mailpieces with the PLANET service code having assignable digits, said method comprising the steps of:
retrieving initial assignable digits for a PLANET service code;
prescribing said assignable digits with a PLANET service code;
associating said PLANET service code with a mailpiece from the batch of mailpieces;
determining if another mailpiece is present in said batch of mailpieces;
changing the assignable digits if another mailpiece is determined present in said batch of mailpieces; and
associating the PLANET service code having said changed assignable digits with the another present mailpiece.

2. A method as recited in claim 1, wherein the PLANET service code is a destination CONFIRM barcode for tracking mailpieces in the United States Postal System.

3 A method as recited in claim 2, wherein the assignable digits consist of at least four digits.

4. A method as recited in claim 1, wherein the step of changing the assignable digital includes incrementing the assignable digits by a one count.

5. A method as recited in claim 1, wherein the step of associating the PLANET service code includes storing the PLANET service code having the assignable digits in a database in correspondence with a mailpiece.

6. A method for generating a PLANET service code having assignable digits for a batch of mailpieces with each mailpiece having a known POSTNET service code, said method comprising the steps of:
retrieving initial assignable digits for a PLANET service code;
prescribing said assignable digits with a PLANET service code;
associating said PLANET service code with a mailpiece from the batch of mailpieces;
determining if another mailpiece is present in said batch of mailpieces;
if another mailpiece is present, determining if said another mailpiece has an associated POSTNET service code that was associated with a previous mailpiece in said batch of mailpieces, and if yes, changing the assignable digits; and
associating the PLANET service code having the assignable digits, whether or not changed, with said another present mailpiece.

7. A method as recited in claim 6, wherein the PLANET service code is a destination CONFIRM barcode for tracking mailpieces in the United States Postal System.

8. A method as recited in claim 7, wherein the assignable digits consist of at least four digits.

9. A method as recited in claim 6, wherein the step of changing the assignable digital includes incrementing the assignable digits by a one count.

10. A method as recited in claim 6, wherein the step of associating the PLANET service code includes storing the PLANET service code having the assignable digits in a database in correspondence with a mailpiece.

11. A method for generating a PLANET service code having assignable digits for a batch of mailpieces with each mailpiece having either a known or unknown POSTNET service code, said method comprising the steps of:
retrieving initial assignable digits for a PLANET service code;
prescribing said assignable digits with a PLANET service code;
associating said PLANET service code with a mailpiece from the batch of mailpieces;
determining if another mailpiece is present in said batch of mailpieces;
if another mailpiece is present, determining if said another mailpiece has a POSTNET service code associated with it, and if no, changing said assignable digits;
if another mailpiece is present with a POSTNET service code associated with it, determining if said associated POSTNET service code has been associated with a previous mailpiece in said batch of mailpieces, and if yes, changing the assignable digits; and
associating the PLANET service code having the assignable digits, whether or not changed, with said another mailpiece.

12. A method as recited in claim 11, wherein the PLANET service code is a destination CONFIRM barcode for tracking mailpieces in the United States Postal System.

13. A method as recited in claim 12, wherein the assignable digits consist of at least four digits.

14. A method as recited in claim 11, wherein the step of changing the assignable digital includes incrementing the assignable digits by a one count.

15. A method as recited in claim 11, wherein the step of associating the PLANET service code includes storing the PLANET service code having the assignable digits in a database in correspondence with a mailpiece.
